(19) United States
(12) Patent Application Publication
(10) Pub. No.: US 2025/0106508 A1
(43) Pub. Date: Mar. 27, 2025

(54) TECHNIQUES FOR ELIMINATING VIEW ANGLE LOSS IN IMAGE STABILIZED VIDEO

(71) Applicant: Advanced Micro Devices, Inc., Santa Clara, CA (US)

(72) Inventor: Po-Min Wang, Hsinchu (TW)

(73) Assignee: Advanced Micro Devices, Inc., Santa Clara, CA (US)

(21) Appl. No.: 18/476,011

(22) Filed: Sep. 27, 2023

(51) Int. Cl. H04N 23/68; H04N 5/265

(52) U.S. Cl. CPC H04N 23/683; H04N 5/265; H04N 23/6811

(57) ABSTRACT

A technique for generating video is provided. The technique includes obtaining a plurality of source frames with a wide-angle camera and a narrow-angle camera; identifying a plurality of central portions and a plurality of peripheral portions of the plurality of source frames based on image stabilization; and combining the plurality of central portions and the plurality of peripheral portions to generate a plurality of resulting frames of an output video.

### BACKGROUND

Video capture techniques can exhibit shakiness due to camera movement during capture. Many techniques for reducing such shakiness-referred to as “image stabilization”-exist. Improvements in image stabilization techniques are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 illustrates a motion compensation technique applied using a narrow-angle camera, according to an example;

FIG. 3 illustrates a comparison of view angles between a narrow-angle camera and a wide-angle camera, according to an example;

FIGS. 4A-4C illustrate operations for generating a video using a sequence of source frames taken from a wide-angle camera and a narrow-angle camera, according to an example;

FIGS. 5A-5C illustrate additional operations for generating resulting frames of an output video from source frames obtained with a wide-angle camera and a narrow-angle camera, according to an example; and

FIG. 6 is a flow diagram of a method for generating a video, according to an example.

### DETAILED DESCRIPTION

A technique for generating video is provided. The technique includes obtaining a plurality of source frames with a wide-angle camera and a narrow-angle camera; identifying a plurality of central portions and a plurality of peripheral portions of the plurality of source frames based on image stabilization; and combining the plurality of central portions and the plurality of peripheral portions to generate a plurality of resulting frames of an output video.

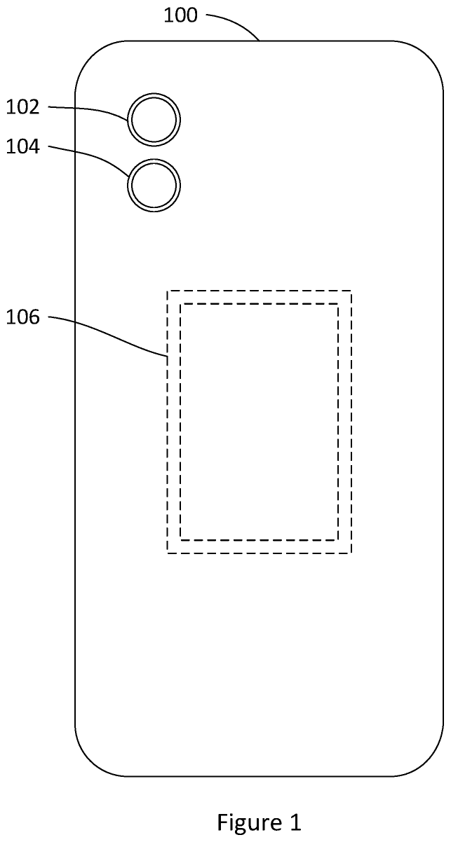

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, a processor 106, a wide-angle camera 102, and a narrow-angle camera 104. In various examples, the device 100 also includes other components, such as memory, auxiliary devices, storage (e.g., non-volatile memory), interconnects, or other elements not explicitly shown.

In various alternatives, the processor 106 include a central processing unit (CPU), a graphics processing unit (GPU), a CPU and GPU located on the same die, or one or more processor cores, wherein each processor core can be a CPU, a GPU, or a neural processor. In various alternatives, the die on which the processor 106 is located also includes system memory. In other alternatives, system memory is included on a different die than the processor 106. The memory includes a volatile or non-volatile memory, for example, random access memory (RAM), dynamic RAM, or a cache.

In examples where the device 100 includes storage, the storage includes a fixed or removable storage, for example, without limitation, a hard disk drive, a solid state drive, an optical disk, or a flash drive. In examples where the device 100 includes one or more auxiliary devices, the one or more auxiliary devices include, without limitation, one or more auxiliary processors, and/or one or more input/output (“IO”) devices. The auxiliary processors include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor is implementable as a programmable processor that executes instructions, a fixed function processor that processes data according to fixed hardware circuitry, a combination thereof, or any other type of processor.

The one or more IO devices include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

The wide-angle camera 102 is able to capture an image with a field of view that is larger than the field of view of images captured by the narrow-angle camera 104. That is, the wide-angle camera 102 is able to capture a larger portion of a scene than the narrow-angle camera 104. Herein, the term “the cameras” sometimes refers collectively to both the wide-angle camera 102 and the narrow-angle camera 104.

The processor 106 is capable of controlling various aspects of the device 100, such as normal operations including obtaining inputs, performing processing, and generating outputs. Part of the operations of the processor 106 includes controlling the cameras to capture images, processing those images, and storing and/or presenting those images on a display. The processor 106 is capable of using either or both of the cameras to capture video as a sequence of frames. To do this, the processor 106 periodically captures images with one or both of the cameras and combines those images into a video.

The processor 106 and the cameras are capable of utilizing an image stabilization technique to compensate for motion of the cameras during video capture. More specifically, if the cameras move while capturing a sequence of images for a video are being captured, then the view seen by the cameras will vary over time. The processor 106 applies electronic image stabilization to compensate for this movement. Specifically, from the entire frame captured by a particular camera (e.g., the narrow-angle camera 104), the processor 106 selects a portion of that frame that is common with other frames in a sequence of frames, tracking the movement of content within the view. The processor 106 combines these portions for each frame into a sequence of frames that is stabilized. However, because the processor 106 has to select only a portion of each originally captured frame, the resulting video has a narrower field of view than the camera with which the frames are captured. It can thus be said that, in generating a motion-compensated video, the device 100 loses field of view.

For this reason, techniques are provided herein by which the processor 106 combines portions of frames from both the wide-angle camera 102 and the narrow-angle camera 104 to “restore” field of view to motion compensated video. According to these techniques, the processor 106 obtains a central, common portion of a frame with the narrow-angle camera 104 and obtains a peripheral portion with the wide-angle camera 102. Then, the processor 106 combines these portions to obtain a “restored” frame. The processor 106 performs these steps for each frame of a sequence of frames and combines the sequence into a video. In determining the central, common portion, the processor 106 identifies common content within the view and selects the central portion by tracking that common content. The processor 106 also selects the peripheral view as the portion of the view from the wide-angle camera 102 that surrounds the central portion. Additional details follow.

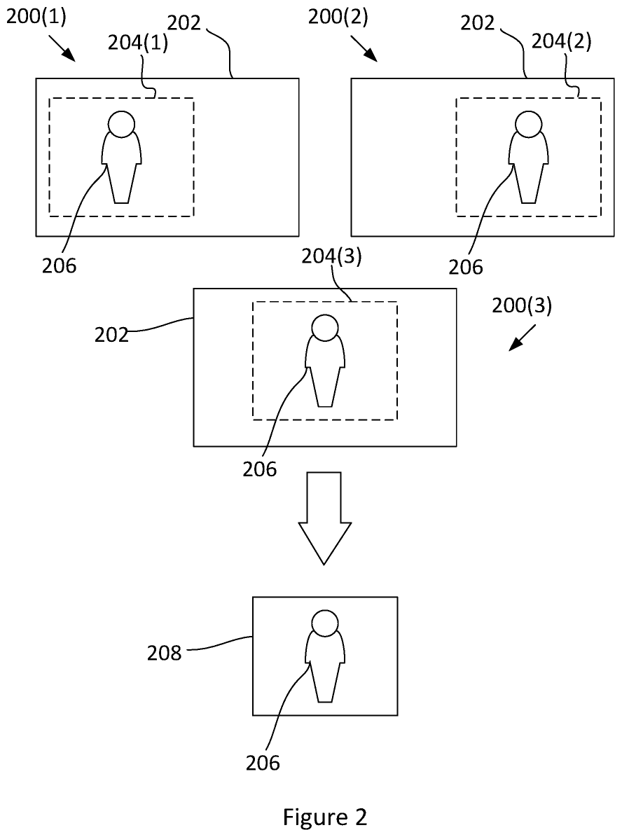

FIG. 2 illustrates a motion compensation technique applied using a narrow-angle camera 104, according to an example. A series of frames 200 are shown—a first frame 200(1), a second frame 200(2), and a third frame 200(3). An object 206 is present in each of the frames 200. Due to motion of the device 100, the object 206 is at a different location in each of the frames 200. In the first frame 200(1), the object 206 is towards the left of the frame 200(1). In the second frame 200(2), the object 206 is towards the right of the frame 200(2). In the third frame 200(3), the object 206 is towards the middle of the frame 200(3).

As can be seen, the object 206 moves throughout the frame 200. It is not possible to generate video using the entire frame while also keeping the object 206 in the same location within the frame. For example, in the first frame 200(1) a significant portion of the scene to the left of the object 206 is omitted but is shown in the frame 200(2). Similarly, a significant portion of the scene to the right of the object 206 is omitted from the frame 200(2) but is included in frame 200(1). As can be seen, it is not possible to include all of the content captured in both frames 200 while maintaining the same view. Thus, in one example, motion compensation includes reducing the field of view as compared with the entirety of the captured content, to provide frames that cover approximately the same area of a scene.

To perform this motion compensation, the processor 106 identifies common areas 204 in each frame and generates new, motion compensated frames as output video 208. The processor 106 uses any of a variety of techniques to identify the common areas 204 in each frame 202. In an example, the processor 106 uses a motion prediction technique to identify movement between frames and determines the common area 204 based on this movement. Any other technically feasible technique may be used by the processor 106 to identify the common areas 204 between frames. As can be seen, the final output video 208 has a much smaller area than the original frames 202 from which that output video 208 is derived. Techniques presented herein utilize a narrow-angle camera 104 in conjunction with a wide-angle camera 102 to provide an image stabilized video having a wide angle of view than if only the narrow-angle camera 104 were used. Moreover, the central portion, likely to include material of interest, is provided with greater detail than if a wide-angle camera 102 had been used exclusively.

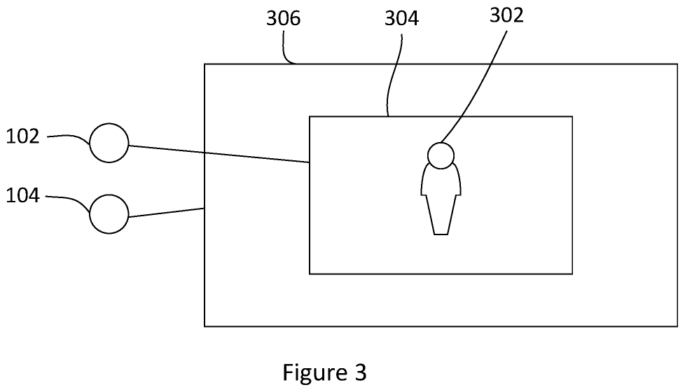

FIG. 3 illustrates a comparison of view angles between a narrow-angle camera 102 and a wide-angle camera 104, according to an example. As can be seen, the narrow-angle camera 102 produces a narrow-angle view 304 and the wide-angle camera 104 produces a wide-angle view 306. The means by which the views differ is typically through difference in lens possessed by each of the cameras. In an example, the wide-angle camera 104 has a fixed lens that has a wider view than a fixed lens possessed by the narrow-angle camera 102.

In general, there is a trade-off between view angle and detail of objects in a scene. Given the same sensor size and characteristics, a camera capturing an image with a wider angle of view captures more of a scene but captures less detail for the objects in the scene than a camera capturing an image with a narrower angle of view. Thus, within the narrow-angle view 304, the narrow-angle camera 102 captures greater detail than the wide-angle camera 104. However, as can be seen, the wide-angle camera 104 captures more of the scene than the narrow-angle camera 102. Note that it is possible that the different cameras have different sensor characteristics, and thus the relative detail captured in each portion may not be exactly as indicated above. For example, in some examples, the wide-angle camera 104 has a larger sensor, a sensor with better optical characteristics, and/or a larger sensor than the narrow-angle camera.

Regarding the views for the different cameras, in the example shown, the narrow-angle view 304 is centered within the wide-angle view 306. However, this is not necessarily what occurs, as the two different cameras are typically at two different physical locations. In other words, the views can be slightly offset vertically, horizontally, or a combination of both.

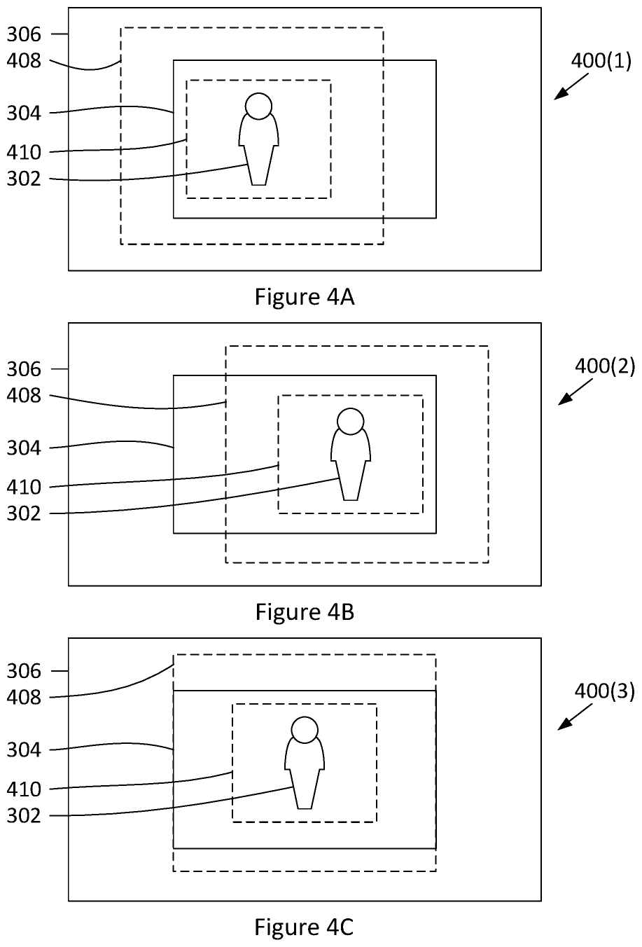

FIGS. 4A-4C illustrate operations for generating a video using a sequence of source frames 400 taken from a wide-angle camera 104 and a narrow-angle camera 102, according to an example. A sequence of three source frames 400 is shown: frame 1 400(1), frame 2 400(2), and frame 3 400(3). In a first source frame 400(1), the device 100 is oriented in such a way that the object 302 is roughly in the center of the narrow-angle view 304 and the wide-angle view 306. In a second source frame 400(2), the device 100 is oriented in such a way that the object 302 is more to the right than in the first source frame 400(1). In a third source frame 400(3), the device 100 is oriented in such a way that the object 302 is more to the left than in the first source frame 400(1). In some examples, the three illustrated source frames 400 are sequentially captured by the cameras. In other words, in some examples, the illustrated source frames 400 are frames captured one after the other in time, with no intervening frames. In other examples, these frames represent frames that are not consecutive, and have intervening frames. In some examples, the frames are taken at periodic time points (such as every 1/30th of a second).

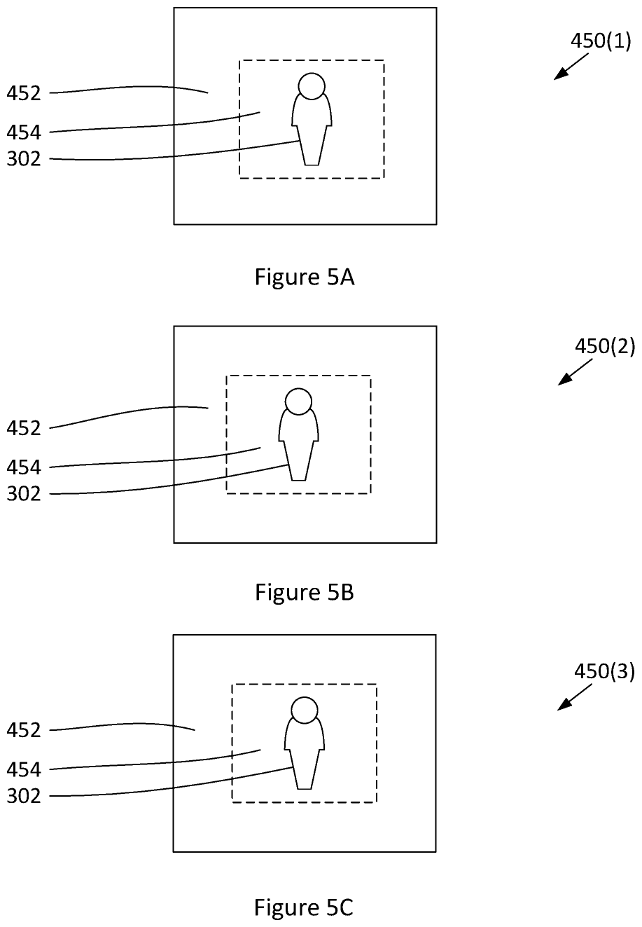

In each of the source frames 400, the object 302 is illustrated within the narrow-angle view 304 and the wide-angle view 306. In addition to these views, a selected narrow-angle portion 410 and a selected wide-angle portion 408 are illustrated. The selected narrow-angle portion 410 and selected wide-angle portion 408 are collectively referred to as “selected portions” herein. The processor 106 constructs generated frames 450, illustrated in FIGS. 5A-5C, based on the selected portions of the source frames 400.

FIGS. 5A-5C illustrate additional operations for generating resulting frames 450 of an output video from source frames 400 obtained with a wide-angle camera 104 and a narrow-angle camera 102, according to an example. The resulting frames 450 include a central portion 454, obtained with the narrow-angle camera 102 and a peripheral portion 452, obtained with the wide-angle camera 104.

Now discussing FIGS. 4A-4C and 5A-5C together, the processor 106 generates the resulting frames 450 from the source frames 400 in the following manner. As can be seen in FIGS. 4A-4C, the source frames 400 include the “raw” content obtained from the cameras, which exhibit movement. In the examples, the movement results in the object 302 being at different locations in different subject frames 400. The processor 106 identifies a central portion 410 of the narrow-angle view 304 and identifies a peripheral portion 408 of the wide-angle view 306 in each frame. The processor 106 identifies the central portion 410 in any technically feasible manner. In some examples, the processor 106 uses a motion compensation technique, tracking objects through the different source frames 400 to determine which portion of the narrow-angle view 304 to use as the central portion 410. In an example, the processor 106 determines an initial position of content for a scene in a first source frame 400 and determines an initial position of the central portion 410 of the first source frame 400 based on the initial position of the content. In a second source frame 400, the processor 106 determines that the content moves to the right and thus determines that the central portion 410 moves to the right. In a third source frame 400, the processor 106 determines that the content moves to the left and thus determines that the central portion 410 moves to the left. In general, the processor 106 identifies the central portion 410 by tracking content of the scene, to minimize apparent motion of such content within a resulting video.

The processor 106 obtains the peripheral portion 408 of the wide-angle view 306 as the portion that surrounds the central portion 410. In some examples, the processor 106 determines which portion of the wide-angle view 306 is the peripheral portion 408 by determining which portion of the wide-angle view 306 corresponds to the central portion 410 of the narrow-angle view 304 and then obtaining the portion that surrounds that portion of the wide-angle view 306. In some examples, the processor 106 knows how to map areas of the narrow-angle view 304 to areas of the wide-angle view 306. In an example, the processor 106 knows that a central point of the narrow-angle view 304 corresponds to a central point of the wide-angle view 306. In some examples, the two central points do not directly correspond, as the cameras are displaced with respect to each other. Thus, the processor 106, in some examples, adds a displacement to the central location of the wide-angle view 306 to obtain a corresponding central position in the wide-angle view 306. In some examples, the processor 106 is able to map any feature (e.g., points or lines) within the narrow-angle view 304 to a corresponding feature within the wide-angle view 306. In various examples, the processor 106 considers aspects such as focal length, focusing distance, distance between wide-angle camera 102 and narrow-angle camera 104, or any other aspect to map between the narrow-angle view 304 and the wide-angle view 306. In general, the processor 106 determines the central portion 410 of the narrow-angle view 304 by tracking a scene to compensate for motion and determines the peripheral portion by correlating an area of the wide-angle view 306 to an area around the central portion 410 of the narrow-angle view 304.

To generate the resulting frame 450, the processor 106 adds the central portion 454 of the narrow-angle view 304 to the peripheral portion 452. In some examples, the processor 106 upscales the peripheral portion 452 to match the resolution of the narrow-angle view 304. For example, if the resulting frame 450 has the same magnification as the narrow-angle view 304, then since the wide-angle view 306 has a lower magnification, the content taken from the wide-angle view 306 is upscaled to match the higher magnification of the narrow-angle view 304.

The terms “narrow-angle portion” and “central portion,” referring to the central portion 410 and central portion 454, are sometimes used interchangeably herein. Similarly, the terms “wide-angle portion” and “peripheral portion,” referring to the peripheral portion 408 and peripheral portion 452, are sometimes used interchangeably herein.

In FIGS. 5A-5C, the resulting frames 450 which are a result of operations performed on the source frames 400, are shown. Resulting frame 450(1) is derived from source frame 400(1), resulting frame 450(2) is derived from source frame 400(2), and resulting frame 450(3) is derived from source frame 400(3). Although the object 302 moves within the narrow-angle view 304 and the wide-angle view 306 of FIGS. 4A-4C, the object 302 is stationary within the resulting frames 450. In addition, the extents of the resulting frames 450 are larger than the extents of the central portion 410, representing the content that is common between the source frames 400.

It should be understood that although only three frames are shown, this number is selected simply as an example and that the techniques described could be applied to a video including any number of frames.

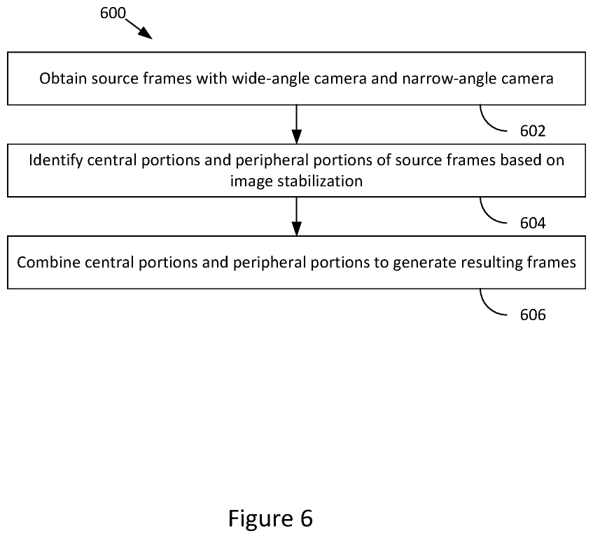

FIG. 6 is a flow diagram of a method 600 for generating a video, according to an example. Although described with respect to the system of FIG. 1-5C, those of skill in the art will understand that any system configured to perform the steps of the method 600 in any technically feasible order falls within the scope of the present disclosure.

At step 602, a device 100 (e.g., via a wide-angle camera 102, a narrow-angle camera 104, and a processor 106) obtains source frames 400. In some examples, the source frames 400 include a narrow-angle view 304 obtained with the narrow-angle camera 102 and a wide-angle view 306 obtained with the wide-angle camera 104. In some examples, the view of the scene is displaced to a degree as a result of the wide-angle camera 104 being displaced from the narrow-angle camera. However, in those examples, there is significant overlap between such views. In some examples, the cameras obtain a sequence of frames from which a video is eventually constructed. In some examples, this sequence includes partially or fully consecutive frames or frames that are not consecutive. In some examples, the narrow-angle view 304 has greater magnification that the wide-angle view 306. Thus, the narrow-angle view 304 has greater detail while the wide-angle view 306 includes more content.

At step 604, the processor 106 identifies a central portion 454 and a peripheral portion 452 of the source frames 400. In some examples, the processor 106 identifies central portions 454 of multiple frames based on an electronic image stabilization technique. As described elsewhere herein, the electronic image stabilization technique attempts to maintain the content of the frames in a constant location. To perform this operation, the processor 106 selects a portion of the narrow-angle view 304 in each frame, where the position of this selected portion is chosen to keep the positions of the content relatively constant in each frame. Any technically feasible technique may be used to perform this selection. In some examples, a motion compensation-based technique is used. In some such techniques, the processor 106 determines a motion vector from one frame to the next based on a cost minimization technique. More specifically, a cost comprises a value that represents a comparison between two frames. In some examples, this value is the sum of absolute differences between pixels of the two frames. This sum of absolute differences represents a sum of the absolute values of differences in pixel values. Content that is more similar has a lower sum of absolute differences than content that is less similar. Thus, the motion compensation technique identifies portions of two frames that are most similar by testing out different combinations of portions of the two frames and identifying the combination with the lowest sum of absolute differences. In some examples, the processor 106 continuously applies this technique to identify, from a series of frames, central portions 410 of such frames that “match” in terms of content. Although an example technique for performing image stabilization and identify central portions 410 has been described, in other examples, other techniques are used. Any technically feasible technique may be used to perform image stabilization and identify central portions.

Identifying the peripheral portion 454 includes identifying, within the wide-angle view 306, a portion that surrounds the portion of the wide-angle view 306 corresponding to the central portion 410. More specifically, because the central portion 410 is from the narrow-angle view 304, the processor 106 correlates the central portion 410 to a corresponding central portion of the wide-angle view 306. This correlation is performed in any technically feasible manner. In an example, the processor 106 determines the left, right, top, and bottom extents of the central portion 410 within the narrow-angle view 304, and identifies corresponding extents within the wide-angle view 306 based on the difference in magnification (for example, reducing the extents by a ratio of the magnification of the wide-angle view 306 to the narrow-angle view 304), and enlarges those extents to obtain the extents of the peripheral portion 408. In some examples, the processor 106 applies additional compensation such as compensation for difference positions of the cameras, differences based on focusing distance, or based on other aspects. The result of these operations is that the processor 106 has obtained, for a source frame 400, a central portion 410 and a peripheral portion 408.

At step 606, the processor 106 combines the central portion 410 and the peripheral portion 408 into a resulting frame 450. In some examples, such combination includes generating a resulting frame 450 in which the peripheral portion 408 occupies a peripheral area and the central portion 410 occupies a central area. In some examples, this operation includes upscaling the peripheral portion 408 based on the difference in magnification between the cameras, so that the peripheral portion 408 has the same resolution as the central portion 410. In some examples, this technique is performed continuously for a series of frames so that a video is generating having the characteristics described herein. In various examples, the resulting video is encoded, upscaled, and/or transmitted (e.g., by the processor 106), and/or used in any other technically feasible way.

In some examples, the processor 106 is implemented as a hardware processor such as a programmable processor, field-programmable gate array, fixed function processor, application-specific integrated circuit, or other processor. In some examples, the where this document states that the processor 106 performs a certain action, this should be understood as indicating that the processor is configured to (e.g., based on a circuitry configuration) or is programmed to perform the action. Thus, a description of actions performed by the processor 106 should be interpreted as providing support for a hardware processor that is configured to perform those actions, software (including a non-transitory computer-readable medium that stores instructions) that, when executed by a processor, cause the processor to perform those actions, or a combination of hardware and software.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for generating video, the method comprising:
obtaining a plurality of source frames with a wide-angle camera and a narrow-angle camera;
identifying a plurality of central portions and a plurality of peripheral portions of the plurality of source frames based on image stabilization; and
combining the plurality of central portions and the plurality of peripheral portions to generate a plurality of resulting frames of an output video.

2. The method of claim 1, wherein the plurality of source frames comprise frames taken a consecutive, periodic time points.

3. The method of claim 1, wherein identifying the plurality of central portions based on image stabilization comprises identifying portions of the source frames to minimize apparent motion of content.

4. The method of claim 3, wherein the identifying the plurality of central portions based on the image stabilization comprises minimizing a loss function.

5. The method of claim 1, wherein the central portions are taken from the narrow-angle camera and the peripheral portions are taken from the wide-angle camera.

6. The method of claim 1, wherein identifying the plurality of peripheral portions comprises identifying areas around the central portions in a plurality of wide-angle views taken with the wide-angle camera.

7. The method of claim 1, wherein combining the plurality of central portions and the plurality of peripheral portions comprises surrounding the plurality of central portions with the plurality of peripheral portions to generate the plurality of resulting frames.

8. The method of claim 1, wherein combining the plurality of central portions and the plurality of peripheral portions comprises upscaling the plurality of peripheral portions.

9. The method of claim 1, further comprising performing one or more of encoding, storing, and transmitting the output video.

10. A system for generating video, the system comprising:
a wide-angle camera and a narrow-angle camera; and
a processor configured to:
obtain a plurality of source frames with the wide-angle camera and the narrow-angle camera;
identify a plurality of central portions and a plurality of peripheral portions of the plurality of source frames based on image stabilization; and
combine the plurality of central portions and the plurality of peripheral portions to generate a plurality of resulting frames of an output video.

11. The system of claim 10, wherein the plurality of source frames comprise frames taken a consecutive, periodic time points.

12. The system of claim 10, wherein identifying the plurality of central portions based on image stabilization comprises identifying portions of the source frames to minimize apparent motion of content.

13. The system of claim 12, wherein the identifying the plurality of central portions based on the image stabilization comprises minimizing a loss function.

14. The system of claim 10, wherein the central portions are taken from the narrow-angle camera and the peripheral portions are taken from the wide-angle camera.

15. The system of claim 10, wherein identifying the plurality of peripheral portions comprises identifying areas around the central portions in a plurality of wide-angle views taken with the wide-angle camera.

16. The system of claim 10, wherein combining the plurality of central portions and the plurality of peripheral portions comprises surrounding the plurality of central portions with the plurality of peripheral portions to generate the plurality of resulting frames.

17. The system of claim 10, wherein combining the plurality of central portions and the plurality of peripheral portions comprises upscaling the plurality of peripheral portions.

18. The system of claim 10, wherein the processor is further configured to perform one or more of encoding, storing, and transmitting the output video.

19. A non-transitory computer-readable medium storing instructions that, when executed by a processor, cause the processor to perform operations comprising:
obtaining a plurality of source frames with a wide-angle camera and a narrow-angle camera;
identifying a plurality of central portions and a plurality of peripheral portions of the plurality of source frames based on image stabilization; and
combining the plurality of central portions and the plurality of peripheral portions to generate a plurality of resulting frames of an output video.

20. The non-transitory computer-readable medium of claim 19, wherein the plurality of source frames comprise frames taken a consecutive, periodic time points.
